(19) United States
(12) Patent Application Publication
(10) Pub. No.: US 2008/0262123 A1
(43) Pub. Date: Oct. 23, 2008

(54) Carbon Black Masterbatches and Method for Making the Same

(76) Inventor: Balachandra Chakkingal Sekhar, Petaling Jaya (MY)

Correspondence Address: Husch Blackwell Sanders, LLP;Welsh & Katz, 120 S RIVERSIDE PLAZA, 22ND FLOOR, CHICAGO, IL, 60606, US

(21) Appl. No.: 11/569,586

(22) PCT Filed: May 24, 2005
(86) PCT No.: PCT/SG05/00158

§ 371 Date: Nov. 24, 2006

(30) Foreign Application Priority Data
May 24, 2004 (MY) PI 20041981

(51) Int. Cl. C08J 3/22

(52) U.S. Cl. 523/351

(57) ABSTRACT

This invention relates to a process for the preparation of rubber carbon black masterbatches containing 70% by weight and above of carbon black. Prevulcanized latex is used as the medium to incorporate the carbon black powder to produce such rubber carbon black masterbatches. Either a small amount of raw latex or a small amount of process oil or both may be mixed with the prevulcanized latex before incorporating the carbon black powder.

### FIELD OF THE INVENTION

The present invention relates to a process for the preparation of carbon black masterbatches. In particular, this invention relates to a process for the preparation of carbon black masterbatches of rubber latex.

### BACKGROUND OF THE INVENTION

In the rubber manufacturing industry various forms of carbon black in differing proportions are used for reinforcement. The carbon blacks used ranges from soft to highly structured carbon blacks such as ISAF and SAF. The proportion of carbon black used varies from 20 to 50 parts per 100 parts of elastomer; either natural or synthetic elastomer. The problem generally faced by the industry in the use of carbon black stems from the fine nature of carbon black powder which is difficult to handle, hazardous to the people involved in the mixing process and tends to pollute the environment. Carbon black manufacturers have attempted to produce the carbon black in pelletised granular form to avoid the flying of carbon black powder into the atmosphere. The manufacturing industry has so far lived with the problem and the use of large size intermixes at high speeds. While the larger master manufacturers particularly the large tyre makers have incorporated devices to minimize carbon black contamination of workers in their factories, the smaller manufacturers have resorted to custom compounding by centralized operations.

Cabot Corporation, one of the largest carbon black manufacturers having worldwide production facilities have now resorted to producing what is termed carbon black latex rubber composites at their plant in Malaysia. The rubber used in the composite is raw latex and the value of the rubber components of the composite will be equivalent to TSR-L or RSS-1 both of which will not be used by tyre manufacturers who exclusively use the lower grades of TSR 10 and TSR 20 in most of their manufacturing operations. The carbon black content of their composites ranges from 20 to 50 parts per 100 of rubber. This process will not enable the concentration of the black to exceed the 50 parts per 100 parts of rubber. By using prevulcanised natural or synthetic latex, the new process which is the subject of the present invention can attain carbon black concentrations of 900 parts of black per 100 parts of rubber.

This invention provides a method of producing carbon black masterbatch containing 70% by weight and above of carbon black. It should be understood that the term “masterbatch” is used when an excess of the vital ingredient is incorporated in the raw products for subsequent dilution at the mixing phase in the intermix and such carbon black masterbatch may be mixed with any grade of natural rubber or synthetic rubber for manufacturing purposes. This invention achieves the production of such carbon black masterbatch by using prevulcanized latex as the medium to incorporate the carbon black. In the subsequent mixing of this carbon black masterbatch with rubber, the incorporation of the carbon black with rubber and the dispersion of the carbon black in rubber are greatly assisted through the use of the carbon black masterbatch of this invention, thus increasing the dynamic properties of the final product.

### SUMMARY OF THE INVENTION

One embodiment of a process of producing a carbon black masterbatch comprising of diluting prevulcanized latex to a dry rubber content of 10 to 15%, mixing carbon black powder vigorously with the diluted prevulcanized latex and allowing the mixture to coagulate. The prevulcanized latex used is natural latex or synthetic latex, and the proportion of the carbon black powder by weight to the prevulcanized latex is from 70:30 to 90:10.

Another embodiment of a process of producing a carbon black masterbatch wherein a small amount of raw latex can be mixed with the undiluted prevulcanized latex. The raw latex used can be natural latex or synthetic latex. The concentration of raw latex incorporated into the prevulcanized latex is no greater than 10% by weight of the prevulcanized latex. Another embodiment of a process of producing a carbon black masterbatch wherein a small amount of process oil also can be mixed with the undiluted prevulcanized latex. The concentration of the process oil incorporated into the prevulcanized latex is no greater than 10% by weight of the carbon black powder. In another embodiment of a process of producing a carbon black masterbatch wherein a small amount of formic acid is added to the final mix of carbon black and prevulcanized latex.

The process of A carbon black masterbatch comprising 70 to 90 parts of carbon black powder, 30 to 10 parts of prevulcanized latex, 5 to 1 parts of raw latex and 10 to 5 parts of process oil.

### DETAILED DESCRIPTION OF THE INVENTION

The basic embodiment of this invention is hereby described. Prevulcanized latex is firstly diluted to a dry rubber content (DRC) of 10 to 15%. The prevulcanized latex can be either natural latex or synthetic latex. Carbon black is then added to the diluted prevulcanized latex with vigorous stirring. The proportion of the carbon black added can be varied from 70 parts of carbon black to 30 parts of prevulcanized latex to 90 parts of carbon black to 10 parts of prevulcanized latex. A high speed planatory mixer such as the one used in the latex foaming industry, a heavy duty mixer or an efficient mechanical stirrer would essentially aid the uniform incorporation of carbon black and prevulcanised rubber.

The final product mix may desirably be treated with a small quantity of formic acid to ensure total coagulation and rubber coating of the carbon black powder. The final product may be then dried at temperature ranging from 50 to 70° C. in a deep bed or a conveyor belt. The final dry material with a slight amount of moisture retained may be easily pelletised in the size of the usual sugar cubes for easy packing and export. The entire process is best done at a carbon black manufacturing facility.

The type of carbon black used for this process can be selected from and is not limited to High Abrasion Furnace carbon black (HAF), Intermediate Super Abrasion Furnace carbon black (ISAF) or Super Abrasion Furnace (SAF), and the carbon black should be in its powder form only and not granulated form or pelletised form.

In another embodiment of the invention, before the prevulcanized latex is diluted, a small amount of raw latex can be added to the prevulcanized latex and the latex mixture is diluted to a DRC of 10 to 15%. The raw latex can be natural raw latex or synthetic raw latex. In another embodiment of this invention, a small amount of emulsified process oil can also be added to the prevulcanized latex and the mixture is diluted to a DRC of 10 to 15%. In the preferred embodiment of this invention, a small amount of both raw latex and emulsified process oil can be added to the prevulcanized latex and the mixture is then diluted to a DRC of 10 to 15%. The amount of the raw latex incorporated to the prevulcanized rubber should not exceed 10% by weight of the prevulcanized rubber, and the amount of the process oil incorporated into the prevulcanized latex should not exceed 10% by weight of the carbon black incorporated. Although the amount of both the raw latex and process oil in the carbon black masterbatch are negligible, both their presence assists the incorporation and mixing of the carbon black with rubber. The carbon black masterbatch of the preferred embodiment comprises of 70 to 90 parts of carbon black powder, 30 to 10 parts of prevulcanized latex, 5 to 1 parts of raw latex and 10 to 5 parts of process oil.

The tables below illustrates the preparation of the carbon black masterbatch sample as well as advantages obtained thereform and are presented for illustrative purpose only, and therefore are not intended to limit the scope of this invention in any way.

The tables below illustrate the basic elements of the invention.

TABLE 1
Preparation of Samples

| | Prevulcanised | Process oil | | Carbon |
|---|---|---|---|---|
| Masterbatches | rubber latex | (Napthenic oil; | Raw Rubber | Black |
| as described | (DRC) | emulsified) | Latex (DRC) | (ISAF) |
| A | 10 | 10 | — | 90 |
| B | 9 | 10 | 1 | 90 |
| C | 20 | 10 | — | 80 |
| D | 18 | 10 | 2 | 80 |
| E | — | 10 | 100 | 45 |
| (Control Dry | | | | |
| Mix with TSR | | | | |
| 20) | | | | |

TABLE 2
Performance Properties on scale of 1-10
The masterbatches A to D are dry mixed wth TSR 20
to attain 45 parts carbon black to 100 of rubber

| | | Dynamic Properties |
|---|---|---|
| | Dispersion using Electron | Tensile, Tear, Hysterisis, |
| Sample | Micrograph | Flex, Resilience etc. |
| A | 7-8 | >7 |
| B | 8-9 | >8 |
| C | 9-10 | >9 |
| D | 10 | 10 |
| E | 4-6 | >5 |

Although the embodiments of the invention have been described and illustrated, it should be understood that the present invention should not be construed as restricted or limited by the above description of the embodiments or the illustrations. It is contemplated that various modifications and substitutions can be made without departing from the spirit and scope of the following claims.

What we claim is:

1) A process of producing carbon black masterbatch comprising:
a. diluting prevulcanized latex to a dry rubber content of 10 to 15%;
b. mixing the carbon black powder vigorously with the diluted prevulcanized latex; and
c. allowing the mixture to coagulate.

2) A process of producing carbon black masterbatch as claimed in claim 1 wherein said prevulcanized latex is natural latex or synthetic latex.

3) A process of producing carbon black masterbatch as claimed in claim 1 wherein the proportion of the carbon black powder to the prevulcanized latex is from 70:30 to 90:10 by weight.

4) A process of producing carbon black masterbatch as claimed in claim 1 wherein a small amount of raw latex is mixed with the prevulcanized latex before dilution.

5) A process of producing carbon black masterbatch as claimed in claim 4 wherein the raw latex is natural or synthetic latex.

6) A process of producing carbon black masterbatch as claimed in claim 4 wherein the concentration of the raw latex is no greater than 10% by weight of the prevulcanized latex.

7) A process of producing carbon black masterbatch as claimed in claims 1 and 4, wherein a small amount of process oil is mixed as an emulsion with the prevulcanized latex before dilution.

8) A process of producing carbon black masterbatch as claimed in claim 5 wherein the concentration of the process oil is no greater than 10% by weight of the carbon black powder.

9) A process of producing carbon black masterbatch as claimed in claims 1, 5 and 7 wherein a small amount of formic acid is added to the final mix of carbon black and prevulcanized latex.

10) A carbon black masterbatch comprising 70 to 90 parts of carbon black powder, 30 to 10 parts of prevulcanized latex, 5 to 1 parts of raw latex and 10 to 5 parts of process oil.

11) A carbon black masterbatch as claimed in claim 10 produced by the process as claimed in claims 1 to 9.
